(19) United States
(12) Patent Application Publication
(10) Pub. No.: US 2013/0056446 A1
(43) Pub. Date: Mar. 7, 2013

(54) METAL MATRIX CERAMIC WIRE MANUFACTURING TECHNOLOGY AND USAGE

(71) Applicant: James Leach, Westbury, NY (US)

(72) Inventor: James Leach, Westbury, NY (US)

(73) Assignee: SULZER METCO (US) INC., Westbury, NY (US)

(21) Appl. No.: 13/696,927

(22) PCT Filed: May 10, 2011
(86) PCT No.: PCT/US11/35957

§ 371 Date: Nov. 8, 2012

Related U.S. Application Data
(60) Provisional application No. 61/333,566, filed on May 11, 2010.

(51) Int. Cl. C23C 4/06; B32B 37/24

(52) U.S. Cl. 219/76.14; 156/86

(57) ABSTRACT

Thermal spray wire and method of forming thermal spray wire. The thermal spray wire includes an inner layer, a powder material layer surrounding the inner layer, and an outer layer coaxially surrounding and compressing the powder material layer around the inner layer.

### CROSS-REFERENCE TO RELATED APPLICATION

The present application claims the benefit under 35 U.S.C. § 119(e) of U.S. Provisional Patent Application No. 61/333,566 filed May 11, 2010, the disclosure of which is expressly incorporated by reference herein in its entirety.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

The invention relates to wire feedstock for electric arc or thermal spraying processes, and more particularly to a composite wire feedstock having plural layers.

2. Discussion of Background Information

A composite wire for thermal flame application is described in U.S. Pat. No. 5,514,422, the disclosure of which is expressly incorporated by reference herein in its entirety. The composite wire includes a composite coating of co-deposited metal, solid lubricant, and wear resistant particles are plated around a solid wire core. An optional copper protective sheath can be provided to prevent oxidation of the composite coating and to improve feeding through pinch rolls and gun orifices. The composite wire is utilized to produce a metal matrix composite coating along a cylinder bore wall

Spray powders are known, e.g., from U.S. Pat. No. 7,449,249, for coating substrates with a metal matrix. According to the noted patent, a metal matrix can be applied to, e.g., a bearing part, as intermetallic phases or compounds. The disclosure of U.S. Pat. No. 7,449,249 is expressly incorporated by reference herein in its entirety.

### SUMMARY OF THE INVENTION

Embodiments of the invention produce a thermal spray wire to be used for twin-wire arc spray or any other spray process, e.g., a Plasma Transfer Wire Arc (PTWA) Spray where historically a ceramic, cermet, or other semi-conducting and/or insulating wire cannot be used (i.e. ceramic or metal matrix, i.e., ceramic-metal materials) because the spray technology relies on the conductivity of the wire to complete the circuit, and also because it is difficult to produce a wire material from these insulating and/or semi conductive materials that has structural integrity sufficient to feed through the process equipment.

The final material combinations may lend themselves to use for unusual or atypical welding applications as well. This technology would allow the application of low or non-conductivity materials using methods which historically have relied upon conductive coating materials to perform the coating function due to the reliance on the conductivity of the wire feedstock.

In embodiments, a first wire type could be formed as a filled hollow wire, where the hollow wire is filled with a matrix, and the matrix is an insulating and/or semi conductive powder material. An outer conductive alloy (or pure metal) shell would be provided in order to complete the electrical circuit in the application gun for the process to function.

In another embodiment, the outer conductive alloy (or pure metal) shell may be designed to be completely consumed in the application process so as to not add any (or as little as possible) metallic constituents to the core matrix material in the applied coating. The shell is for conducting well enough to melt the other wire constituents in the arc plasma and produce a coating on a substrate.

An example of this technology might be an aluminum oxide layer provided within a thin aluminum shell. During the spray processing, the outer shell would be vaporized by the high operational current, with an aluminum oxide by-product applied to the substrate. The resultant coating would be predominantly aluminum oxide with very small traces of pure aluminum inclusions. Moreover, using oxygen atomizing gas would increase oxide yield and reduce pure metal inclusions. It is envisioned that the conductive shell is between 1 mil (0.025 mm)and about 10 mil (0.250 mm) thick, preferably about 2-5 mil (0.50-0.125 mm) thick. It is also envisioned that the inner diameter of the wire is determinable by the shell thickness.

In the case of metal matrix coatings, where metal and ceramic are used together, the wire is created with an outer “shell” of conductive material that is also required as the metal portion of the matrix of the final coating (production methods not unlike the Metco 405 wire). This outer conductive shell could be a substantially pure metal, or an alloy. The inner core of the wire could be either pure ceramic (insulator), or a ceramic-metal blend (semi conductor), with the metal portion either the final alloy of the desired composition, or a substantially pure metal in predetermined proportion to create the desired metallic alloy constituent in the final coating when combined with the remaining material from the conductive outer shell of the wire.

In further embodiments, a second type of wire builds on the above-described first type of wire by adding a center filament or wire. In this manner, the center wire can be essentially coaxial to the other two layers. Thus, for example, the center wire may be surrounded by an insulating and/or semi conductive matrix, and a conductive alloy (or substantially pure metal) outer shell. The “center wire” need not be a wire at all, as the conductivity of this element may be immaterial depending on the application process and the desired coating.

Using this wire, coatings could be produced onto a substrate using materials that cannot or will not alloy under normal conditions, or the non-conductive elements could be implemented in “wire” or “filament” form in cases where it is cost prohibitive to utilize them in powder form. An example is an outer aluminum shell, with a chromium carbide matrix (compressed powder) and a center filament of polyester.

In other embodiments, the wire can have a conductive metallic outer shell, a ceramic matrix of low or essentially no conductivity contained within, and a single metal alloy core, with the core wire gage and chemical composition modified as needed to produce the desired final coating properties. Other embodiments rely only on the outermost shell being conductive, with the other wire constituents not needing to be metal or metal alloy at all, and not required to be conductive at all. Plastic (polyester) was noted earlier as a possible center wire in this embodiment.

In further embodiments, the outer conductive shell is of appropriate thickness as to be completely vaporized in the process (aluminum, for example), thereby reducing the metal constituent to zero, or near zero in the final coating. An aluminum shell over a packed aluminum oxide powder is a non-limiting example of this technology.

It is envisioned that the outer conductive shell is between about 1 mil (0.025 mm) and about 10 mil (0.25 mm) thickness, preferable about 2-5 mil (0.050-0.125 mm) thickness. It is also envisioned that the central wire or central fiber/filament has a diameter between about 1 mil and a maximum diameter determinable and limited by the inner diameter of the outer conductive shell.

In another embodiment, the central wire or central fiber/filament is coated with the matrix material prior to inclusion into the shell.

In another embodiment, the central wire or central fiber/filament is coated with the matrix material, and this composite is coated with the metal or metal alloy to form the outer conductive shell.

Embodiments of the instant invention are directed to a thermal spray wire includes an inner layer extending longitudinally, a first layer having a packed powder material coaxially surrounding the inner layer, and a second layer coaxially surrounding the first layer. The inner layer includes at least one of a metal and a polymer, the first layer is a conductive or non-conductive layer, and the second layer is conductive.

According to embodiments, the first layer can be at least one of a ceramic, a semi-conductive layer, and a ceramic-metal blend.

In accordance with other embodiments, the second layer may include a metal that is a constituent of a metal portion of a matrix of a final coating.

Further, the second layer may be a pure metal in a predetermined proportion to the first layer.

According to still other embodiments of the invention, the inner layer, the first layer and the second layer can include constituents of a coating to be applied onto a cylinder bore.

Embodiments of the invention are directed to a thermal spray wire that includes an inner layer, a powder material layer surrounding the inner layer, and an outer layer coaxially surrounding and compressing the powder material layer around the inner layer.

In embodiments, the powder material may include a conductive or non-conductive material, and the outer layer may be a conductive material.

According to embodiments, the thermal spray wire can be a precursor to a coating on a cylinder bore.

In accordance with further embodiments, the inner layer may include at least one of a metal and a polymer.

Still further, the inner layer may include at least one of a ceramic, a semi-conductive layer, and a ceramic-metal blend.

According to other embodiments, the inner layer can include at least one of a liquid and gas. Further, an end of the inner layer may be coupleable to a source for at least one of liquid and gas. These liquids and gases can be used as reactive or reducing agents in the coating process.

In accordance with still other embodiments of the instant invention, the outer layer can be a metal that is a constituent of a metal portion of a matrix of a final coating.

According to other embodiments, the outer layer may be a pure metal in a predetermined proportion to the powder material layer.

Moreover, the inner layer, the powder material layer, and the outer layer can include constituents of a coating to be applied onto an engine cylinder bore. In further embodiments, at least one of the inner layer, the powder material layer, and the outer layer may not be a constituent of a coating to be applied onto a cylinder bore.

In accordance still other embodiments of the present invention, the inner layer can be non-conductive. In other embodiments, the inner layer can be a shaped or profiled element having a non-circular cross-section shape.

Still further, the inner layer can be dimensioned to define a ratio of constituent materials for a given cross-section. In other embodiments, the inner layer may be hollow.

Embodiments of the invention are directed to a method of forming a thermal spray wire that includes surrounding an inner layer with a powder material layer, and compressing a conductive sleeve around the powder material layer so that the powder material layer is packed around the inner layer. At least one of the inner layer, the powder material layer, and the conductive sleeve include constituents of a coating to be applied onto an engine cylinder bore.

According to embodiments, the method may further include determining a ratio of constituent materials for a cross-section of the thermal spray wire, and adjusting at least one of dimensions and geometry of at least the inner layer to achieve the ratio.

In accordance with other embodiments, the inner layer can include a shaped or profiled element.

Embodiments of the invention are directed to a thermal spray wire for coating cylinder bores. The thermal spray wire includes an inner layer extending longitudinally, a first layer surrounding the inner layer, and a second layer comprising a compressed packed powder material contained within the first layer and coaxially surrounding the inner layer. The inner layer includes at least one of a metal and a polymer, the second layer is a conductive or non-conductive layer, and the first layer is a conductive material that is structured and arranged to conduct sufficient current from a thermal spraying device to melt the first layer, the second layer and the inner layer for coating the cylinder bores.

In accordance with still yet other embodiments of the present invention, the second layer can be at least one of a ceramic, a semi-conductive layer, and a ceramic-metal blend, and the inner layer may be at least one of a conductor and a non-conductor.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted drawings by way of a non-limiting example embodiment of the present invention, and wherein:

FIG. 1 illustrates an exemplary view of a cored wire according to embodiments;

FIG. 2 illustrates an alternative embodiment of the inner layer;

FIG. 3 illustrates another alternative embodiment of the inner layer;

FIG. 4 illustrates another alternative embodiments of the inner layer; and

FIG. 5 illustrates still another alternative embodiment of the inner layer.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

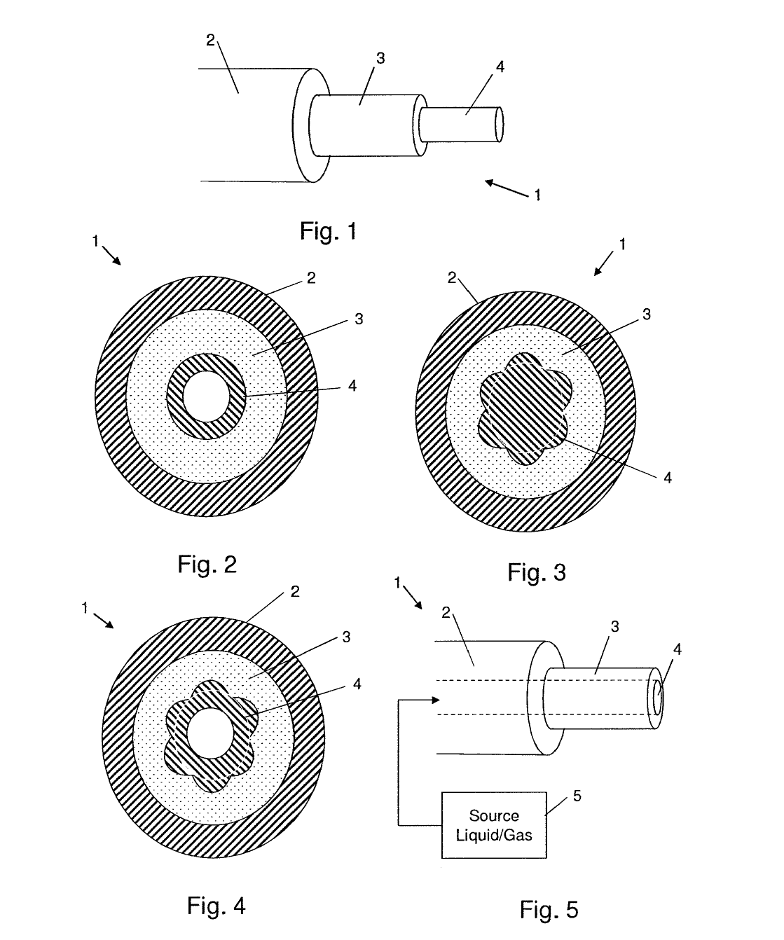

FIG. 1 illustrates an exemplary embodiment of the invention. In particular, a cored wire 1 includes three coaxial layers 2, 3, and 4. Cored wire 1 can be formed with an outer diameter, e.g., about ⅛″ (3.2 mm), that allows its use in a conventional twin wire arc device, e.g., a plasma transfer wire arc (PTWA) spray or other conventional wire application device. Of course, it is understood that the outer diameter of cored wire 1 can be dimensioned for use in other conventional thermal or plasma spray devices without departing from the spirit and scope of the invention. The outer layer 2 is formed by an electrically conductive shell, which can be, by way of non-limiting example, Al, Ni, Cr, Cu, Ti, Fe, Mo, Mb, steel, or alloys thereof. Of course, the selection of a specific material and the thickness thereof for outermost layer 2 depends, as will be discussed below, upon the application in which cord wire 1 is to be utilized. In embodiments, outer layer 2 may preferably be Al, Ni, Cr, Cu, Fe, or alloys thereof, and more preferably Al, Ni, Cu and alloys thereof.

Middle layer 3 may preferably be a non-conductive, insulating layer, e.g., a ceramic, which can include by way of non-limiting example yttria stabilized zirconia (YSZ) or a semi-conductive layer, e.g., a ceramic-metal blend, which can include by way of non-limiting example aluminum oxide. The ceramic or ceramic-metal blend of middle layer 3 may be in the form of a packed powder layer within outer layer 2. Depending upon the specific application of cored wire 1, middle layer 3 may also be formed as or otherwise include as constituent parts of the packed powder, by way of further non-limiting example, plastic, e.g., polyester or polyurethane, graphite, polytetrafluouroethylene (PTFE), a solid lubricant, e.g., hexagonal boron nitride (HBN) or agglomerated boron nitride (ABN). In embodiments, it may be preferred to use a ceramic-metal blend (metal matrix material) as the middle layer. In further embodiments, it may be more preferred to additionally include as part of the middle layer plastic or solid lubricant.

Inner layer 4 can be formed, by way of non-limiting example, as a conductive wire, e.g., a solid metal, such as, e.g., Al, Ni, Cr, Cu, Ti, Fe, Mo, Mb, steel, or alloys thereof; can preferably be Al, Ni, Cr, Cu, Fe, or alloys thereof; and more preferably Al, Ni, Cu and alloys thereof. By way of further non-limiting example, inner layer 4 may be for formed as a non-conductive filament or filaments, such as plastic, such as polyethylene or polyurethane, or other organic or inorganic based fibers. In embodiments, inner layer 4 can also include individual or plural fibers, such as graphite, polytetrafluoroethylene (PTFE), solid lubricant, e.g., HBN or ABN, etc. In further embodiments in which inner layer 4 is non-conductive, inner layer 4 may preferably be plastic, PTFE or solid lubricant, and more preferably polyethylene, polyurethane, HBN or ABN.

The thickness of outer layer 2 is between about 1 mil (0.025 mm) and about 10 mils (0.250 mm), and preferably between about 2 and 5 mil (0.050-0.125 mm) thickness. The thickness of conductive outer layer 3 and the conductivity of the specific material selected for the coating are used in setting the process temperature for cored wire 1. In embodiments, outer layer 2 conducts the current created within the arc spraying device, which heats outer layer 2 and subsequently heats middle layer 3 and then inner layer 4. When outer layer 2 is heated to a process temperature, the conductive material of outer layer 2 melts and the molten material is directed toward a target substrate. Further, middle layer 3 is heated by the arc spraying device in order to melt the insulating material and to additionally direct the molten insulating material toward the target substrate. In this way, a metal-matrix coating can be applied onto a substrate, such as, e.g., a cylinder bore.

In the event additional metal is desired in the coating on the substrate, inner layer 4 can be a conductive layer that is heated to its melting point so that the molten material can be deposited onto the substrate. By way of example, the conductive material of inner layer 4 can be the same or different from the conductive layer forming outer layer 2. This exemplary embodiment may be advantageous in that the amount of conductive material applied to the substrate can be controlled by adjusting the thickness of outer layer 2 and by the cross sectional area of the conductive material of inner layer 4.

Moreover, in other embodiments, the conductive outer layer 2 can be a substantially pure metal provided with a predefined thickness in order to achieve a predetermined proportion with respect to the ceramic or ceramic-metal blend forming middle layer 3 to create the desired alloy constituent in the final coating. Still further, a composite metal coating can be formed on the substrate by forming middle layer 3 as a sacrificial layer, e.g., cellulose or foam, intended to be vaporized or consumed during the application process. In this manner, the molten conductive material from outer layer 2 can be combined with the molten conductive material from inner layer 4 to achieve a composite metal coating on the substrate.

According to other embodiments, outer layer 2 can be a hollow wire, as shown in FIG. 2. In this regard, the outer diameter of inner layer 4 can be increased or decreased, which correspondingly reduces or increases the cross-sectional area of the insulting material for a given thickness of outer layer 2, e.g., about ⅛″ (3.2 mm). In such embodiments, inner layer 4 can be a conductive wire or a non-conductive filament, depending material properties desired for the coating to be applied. Because it is beneficial if the outer diameter of cored wire 1 remains essentially constant over its length and corresponds to the outer diameter of conventional cored wires or wires for use in conventional arc spraying devices, e.g., about ⅛″ (3.2 mm), a ratio of conductive material to insulating material can be controlled by adjusting the outer diameter of inner layer 4 (and sometimes its inner diameter) and/or the thickness of outer layer 2.

In further embodiments, inner layer 3 may be a shaped wire or filament. A shaped or profiled wire feedstock, such as illustrated in FIG. 3, is described in U.S. patent application Ser. No. 11/657,664 filed Jan. 25, 2007, the disclosure of which is expressly incorporated by reference herein in its entirety. As described in the above-noted application, by shaping or profiling the wire feedstock, e.g., to include rounded lobes, wire feed rates can be increased and thermal efficiency can be improved due to the increased surface area of the wire's cross-section exposed to the burner jets. As with the hollow wire or filament, the ratio of conductive material to insulating material can be controlled by adjusting the geometry and/or size of inner layer 4 and/or the thickness of outer layer 2. Further, as illustrated in FIG. 4, shaped wire or filament 4 can be hollow to assist in adjustment of the conductive material/insulating material ratio.

In other embodiments, the process temperature of outer layer 2 can be set so that, rather than applying the conductive material onto the target substrate with the matrix material, the conductive material of outer layer 2 can be melted and vaporized, thereby reducing the amount of metal constituent to zero, or near zero in the final coating. By way of non-limiting example, such a coating may be formed by an aluminum outer layer 3 over an aluminum oxide middle layer and a sacrificial inner layer 4.

Further, inner layer 4 can be a conductive material to be deposited on the substrate that is structured, e.g., as shown in FIGS. 1-4, and arranged in the insulating material to adjust the conductive material/insulating material ratio. In a further alternative, inner layer 4 can be a non-conductive filament, such as a plastic, that acts as a sacrificial layer that is vaporized rather than applied to the substrate. As inner layer 4 in this alternative is not intended for application to the substrate, its geometry and/or dimension can be adjusted to establish a desired ratio of conductive material to insulating material. According to other embodiments, non-conductive inner layer 4 can be a polymer or plastic that is melted and applied to the substrate with the metal and/or insulating material to form inclusion or pores in the coating, e.g., an abradable coating.

In embodiments, inner layer 4, by way of further non-limiting example, can be a gas or liquid. As illustrated in FIG. 5, a hollow insulating middle layer 3 can be provided within outer layer 2. Moreover, the hollow portion in middle layer 3 can be filed with a gas, e.g., air. It is further contemplated that a source 5 can be coupled to an end of the cored wire 1 opposite the flame so that one or more gases can be supplied as inner layer 4 through the hollow in middle layer 3. The specific gas(es) and/or pressure can be selected by the user to further optimize the melting and/or vaporization of the constituent materials in cored wire 1. By way of example, these liquids and gases can be used as reactive or reducing agents in the coating process. In a still further variant, inner layer 4 can be formed by glass, a viscous conductive or non-conductive liquid, or other liquid as desired by the user for enhancing the substrate coating. Again, it is understood that source 5 can also be arranged to be coupled to the end of the cored wire opposite the flame so that one or more liquids can be supplied as inner layer 4 through the hollow of middle layer 3. In this manner, the specific liquid(s) and/or pressure can be selected by the user to further optimize the melting and/or vaporization of the constituent materials in cored wire 1.

According to other embodiments, inner layer 4 can be formed by a various combinations of solid, liquid and gas constituents. In this regard, it is understood that, with the embodiment shown in FIG. 2, a gas or liquid can be supplied to and/or through the hollow opening in inner layer 4 so as to enhance the application of the coating onto the substrate. Further, with regard to the embodiment shown in FIG. 3, it can be contemplated that, when the middle layer 3 is arranged to surround inner layer 4, small channels can be formed between middle layer 3 and the pinch points at which the bases of the rounded lobes meet. It can be understood that gas or liquid can be supplied through these channels in the manner set forth above so as to give the user additional options for the manner in which the substrate may be coated.

Outer layer 2 in a particular embodiment can be a conductive shell formed with a metal that is also required as the metal portion of the matrix of the final coating. In another embodiment, the conductive shell can be a substantially pure metal in predetermined proportion to the ceramic or ceramic-metal blend first layer to create the desired alloy constituent in the final coating.

The cored wire according to the invention can be formed, by way of example, by packing the constituent material of middle layer 3 around the desired material for inner layer 4, and then hammering a tube down around these constituents that forms outer layer 2. In this manner, the constituents of the middle layer material are mechanically packed around the constituents of the inner layer material within and by the outer layer, rather than adhered to the inner layer material by a plating method. Of course, while other processes can be contemplated for producing the cored wire according to the present application without departing from the spirit and scope of the invention, a packed coating around the inner layer is preferable to a plated coating on the inner layer.

The cored wire according to embodiments can be used to apply a coating to an internal portion of cylinder bores of internal combustion engines, natural gas compressor cylinder bores, etc. Of course, as the layers of the disclosed cored wire can be varied in accordance with the user's desired application, the presently described cored wire can find utility in nearly any application in which a coating is to be applied by a thermal spray device to a substrate.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and sprit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A thermal spray wire, comprising:
an inner layer;
a powder material layer surrounding the inner layer; and
an outer layer coaxially surrounding and compressing the powder material layer around the inner layer.

2. The thermal spray wire of claim 1, wherein the powder material comprises a conductive or non-conductive material and the outer layer is a conductive material.

3. The thermal spray wire of claim 1 being a precursor to a coating on a cylinder bore.

4. The thermal spray wire of claim 1, wherein the inner layer comprises at least one of a metal and a polymer.

5. The thermal spray wire of claim 1, wherein the inner layer comprises at least one of a ceramic, a semi-conductive layer, and a ceramic-metal blend.

6. The thermal spray wire of claim 1, wherein the inner layer comprises at least one of a liquid and gas.

7. The thermal spray wire of claim 6, wherein an end of the inner layer is coupleable to a source for at least one of liquid and gas.

8. The thermal spray wire of claim 1, wherein the outer layer is a metal that is a constituent of a metal portion of a matrix of a final coating.

9. The thermal spray wire of claim 1, wherein the outer layer is a pure metal in a predetermined proportion to the powder material layer.

10. The thermal spray wire of claim 1, wherein the inner layer, the powder material layer, and the outer layer comprise constituents of a coating to be applied onto an engine cylinder bore.

11. The thermal spray wire of claim 1, wherein at least one of the inner layer, the powder material layer, and the outer layer is not a constituent of a coating to be applied onto a cylinder bore.

12. The thermal spray wire of claim 1, wherein the inner layer is non-conductive.

13. The thermal spray wire of claim 1, wherein the inner layer is a shaped or profiled element having a non-circular cross-section shape.

14. The thermal spray wire of claim 1, wherein the inner layer is dimensioned to define a ratio of constituent materials for a given cross-section.

15. The thermal spray wire of claim 1, wherein the inner layer is hollow.

16. A method of forming a thermal spray wire, comprising:
surrounding an inner layer with a powder material layer; and
compressing a conductive sleeve around the powder material layer so that the powder material layer is packed around the inner layer,
wherein at least one of the inner layer, the powder material layer, and the conductive sleeve comprise constituents of a coating to be applied onto an engine cylinder bore.

17. The method of claim 16, further comprising:
determining a ratio of constituent materials for a cross-section of the thermal spray wire; and
adjusting at least one of dimensions and geometry of at least the inner layer to achieve the ratio.

18. The method of claim 16, wherein the inner layer comprises a shaped or profiled element.

19. A thermal spray wire for coating cylinder bores, comprising:
an inner layer extending longitudinally;
a first layer surrounding the inner layer; and
a second layer comprising a compressed packed powder material contained within the first layer and coaxially surrounding the inner layer;
wherein the inner layer comprises at least one of a metal and a polymer, the second layer is a conductive or non-conductive layer, and the first layer is a conductive material that is structured and arranged to conduct sufficient current from a thermal spraying device to melt the first layer, the second layer and the inner layer for coating the cylinder bores.

20. The thermal spray wire of claim 19, wherein the second layer is at least one of a ceramic, a semi-conductive layer, and a ceramic-metal blend, and the inner layer is at least one of a conductor and a non-conductor.
